(19) United States
(12) Patent Application Publication
(10) Pub. No.: US 2025/0074056 A1
(43) Pub. Date: Mar. 6, 2025

(54) LAMINATED SUBSTRATE, LIQUID DISCHARGE HEAD, AND METHOD FOR MANUFACTURING LAMINATED SUBSTRATE

(71) Applicant: CANON KABUSHIKI KAISHA, Tokyo (JP)

(72) Inventors: SOUTA TAKEUCHI, Kanagawa (JP); YUKI KOMORI, Tokyo (JP); MASATAKA KATO, Kanagawa (JP)

(21) Appl. No.: 18/818,236

(22) Filed: Aug. 28, 2024

(30) Foreign Application Priority Data
Aug. 30, 2023 (JP) 2023-140399

(51) Int. Cl. B41J 2/14; B41J 2/16

(52) U.S. Cl. CPC B41J 2/14233; B41J 2/161; B41J 2/1628; B41J 2002/14241

(57) ABSTRACT

A laminated substrate includes a silicon substrate, and a silicon compound film stacked on the silicon substrate, wherein the silicon compound film has a through hole, wherein the silicon substrate has a hole communicating with the through hole, and wherein a diameter of the hole is smaller at least at a portion in a depth direction of the hole than a diameter of the through hole on a surface in contact with the silicon substrate.

### BACKGROUND OF THE INVENTION

### Field of the Invention

The present invention relates to a laminated substrate, a liquid discharge head, and a method for manufacturing the laminated substrate.

### Description of the Related Art

As a liquid discharge head used in an inkjet printer or the like, Japanese Patent Application Laid-Open No. 2013-91272 discusses a liquid discharge head in which liquid discharge holes are drilled in a silicon single-crystal substrate.

### SUMMARY OF THE INVENTION

According to an aspect of the present invention, a laminated substrate includes a silicon substrate, and a silicon compound film stacked on the silicon substrate, wherein the silicon compound film has a through hole, wherein the silicon substrate has a hole communicating with the through hole, and wherein a diameter of the hole is smaller at least at a portion in a depth direction of the hole than a diameter of the through hole on a surface in contact with the silicon substrate.

According to another aspect of the present invention, a method for manufacturing a laminated substrate including a silicon substrate and a silicon compound film stacked on the silicon substrate includes forming a through hole in the silicon compound film stacked on the silicon substrate, and forming a hole in the silicon substrate, the hole communicating with the through hole in the silicon compound film, wherein a by-product is generated in the forming the through hole, a portion of the by-product being attached to a sidewall of the through hole in the silicon compound film, wherein the forming the hole is performed in a state where the by-product is attached to the sidewall of the through hole, and wherein the method further comprises removing the by-products after forming the through hole and the hole.

Further features of the present invention will become apparent from the following description of exemplary embodiments with reference to the attached drawings.

### BRIEF DESCRIPTION OF THE DRAWINGS

FIG. 1 is a cross-sectional view of a configuration of a liquid discharge head according to an exemplary embodiment of the present invention.

FIGS. 2A and 2B are partial cross-sectional views of a laminated substrate of the liquid discharge head illustrated in FIG. 1.

FIGS. 3A to 3D are partial cross-sectional views of a process for forming a liquid discharge hole according to a comparative example.

FIG. 4A to 4D are partial cross-sectional views of a process for forming a liquid discharge hole according to the exemplary embodiment of the present invention.

FIGS. 5A and 5B are partial cross-sectional views of shapes of liquid discharge holes that may be generated in the exemplary embodiment.

FIG. 6A to 6D are partial cross-sectional views of a modification example.

### DESCRIPTION OF THE EXEMPLARY EMBODIMENTS

As a size of droplets discharged from a liquid discharge head has been decreased, the liquid discharge hole has been decreased in diameter and the discharge port forming substrate has been made thinner. In such a situation, it has been found that the finish of a side surface of the liquid discharge hole has a large effect on the discharge performance. In order to improve the finish of the side surface of the liquid discharge hole, there is a method by which a silicon oxide film is formed on the surface of the silicon substrate as is discussed in Japanese Patent Application Laid-Open No. 2013-91272. However, the silicon oxide film is likely to cause a change in the diameter of the liquid discharge hole at the boundary with the silicon substrate, and may increase the flow resistance of the liquid discharge hole. Besides the application to the liquid discharge head, in the case of providing a hole in a laminated substrate of a silicon substrate and a silicon oxide film, it is preferable to suppress a change in the diameter of the hole as much as possible at the boundary between the silicon substrate and the silicon oxide film.

The present invention is directed to providing a laminated substrate in which a change in the diameter of a hole at the boundary between a silicon substrate and a silicon oxide film is suppressed, and a method for manufacturing the laminated substrate.

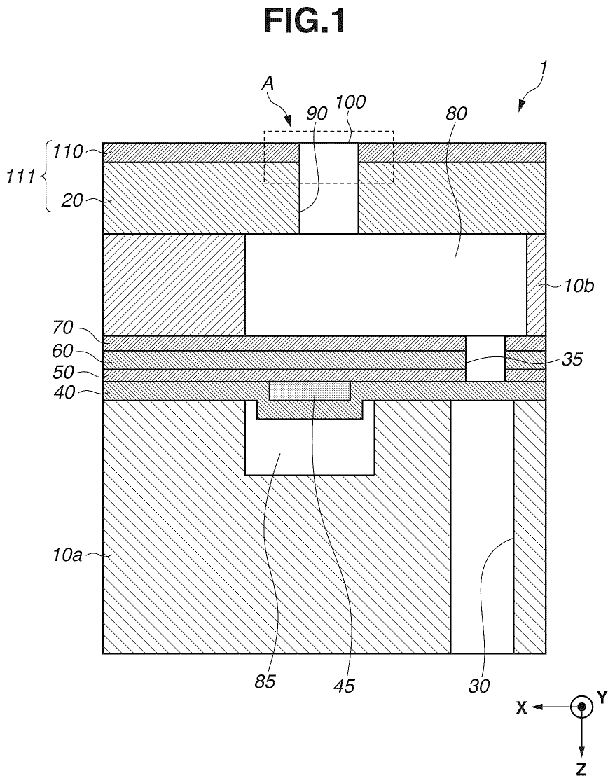

A laminated substrate 111 according to an exemplary embodiment of the present invention will be described with reference to FIGS. 1 to 5B. The exemplary embodiment is merely an exemplification of the present invention, and is not intended to limit the scope of the present invention to the present exemplary embodiment. The laminated substrate of the exemplary embodiment described below is applied to a liquid discharge head using a piezoelectric element, but is also applicable to a liquid discharge head using a heating resistance element or an electrothermal conversion element. The liquid to be discharged is not limited to ink, as long as the liquid can be discharged from the liquid discharge head.

In the following description and drawings, a Z direction refers to the direction in which a silicon substrate and a silicon compound film (silicon oxide film) are stacked, or the depth direction of a through hole or a hole. Any direction perpendicular to the Z direction will be called an X direction. A direction perpendicular to both the Z direction and the X direction will be called a Y direction. The diameter refers to the dimension in the XY plane. The radial direction refers to the direction from the center axis of the hole to the outer periphery of the hole in the XY plane. In the case where the hole or the through hole has a circular cross section, the diameter is equal to the diameter in the XY plane.

### (Configuration of Liquid Discharge Head)

FIG. 1 is a cross-sectional view of (some of) main parts of an ink discharge head 1 of a manufactured printer according to an exemplary embodiment of the present invention. An actuator substrate 10a is made of silicon. The actuator substrate 10a supports a vibration film 60 via a protective film 40 and an insulating film 50. The vibration film 60 is bonded to an insulating film 70. The insulating film 70 forms one surface of a cavity 80, and defines the cavity 80 together with a connection part 10b and a silicon substrate 20. Ink is supplied to the cavity 80 through a through hole 30 that penetrates the actuator substrate 10a in the Z direction and a liquid flow path 35 that penetrates the protective film 40, the insulating film 50, the vibration film 60, and the insulating film 70 in the Z direction. A piezoelectric element 45 is interposed between the protective film 40 and the insulating film 50. A cavity 85 is formed on the side of the protective film 40 opposite to the piezoelectric element 45. The laminated substrate 111 is formed of the silicon substrate 20 and a silicon compound film 110. The silicon substrate 20 has a liquid discharge hole 90 communicating with the cavity 80. A discharge port 100 through which ink is discharged is formed on the most downstream side of the liquid discharge hole 90 in the discharge direction. The diameter of the discharge port 100 is determined by the amount of ink discharged, and is generally about 5 μm to 50 μm. When a driving voltage is applied from a power source (not illustrated) to the piezoelectric element 45, the vibration film 60 vibrates, and the cavity 80 repeatedly expands and contracts. When the ink in the cavity 80 is pressurized, the ink passes through the liquid discharge hole 90 and is discharged from the discharge port 100.

### (Shape and Composition of Liquid Discharge Hole)

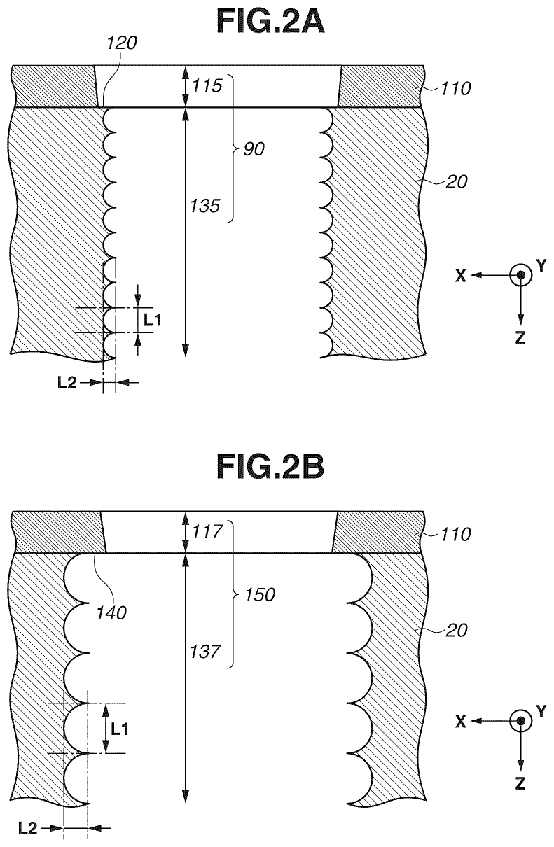

FIGS. 2A and 2B are enlarged views of a part A in FIG. 1, illustrating a partial cross section of the laminated substrate 111. FIG. 2A illustrates the silicon compound film 110, a through hole 115 in the silicon compound film 110, the silicon substrate 20, and a through hole 135 in the silicon substrate 20 according to the present exemplary embodiment. The cross sections of the through hole 115 and through hole 135 are almost circular at any position in the Z direction. The through hole 115 communicates with the through hole 135 to form the liquid discharge hole 90. The central axes of the through hole 115 and through hole 135 are almost coincident. The silicon compound film 110 preferably contains one or more of SiO, SiO₂, Si₃N₄, SiN, SiC, SiON, SiOC, SiCN, and SiOCN, and is preferably a silicon oxide film in particular. The present exemplary embodiment will be described on the assumption that the silicon compound film 110 is a silicon oxide film. The through hole 135 in the silicon substrate 20 is an example of a hole, and the hole may be a recess portion with a bottom. The through hole 135 is formed in the silicon substrate 20 by the Bosch process using the silicon compound film 110 as a mask. The Bosch process refers to a dry etching process in which isotropic etching, formation of a sidewall protective film, and anisotropic etching are repeated.

The diameter of the through hole 115 in the silicon oxide film 110 increases monotonically as farther away from the boundary plane with the silicon substrate 20. Because the silicon oxide film 110 is located outside the silicon substrate 20, that is, on the downstream side in the ink discharge direction, at least the downstream side of the liquid discharge hole 90 has a relatively smooth tapered side surface. A protrusion portion 120 protruding inward of the through hole 135 is formed on the boundary plane of the silicon substrate 20 with the silicon oxide film 110. The protrusion portion 120 is made of silicon.

FIG. 2B illustrates a silicon compound film 110, a through hole 117 in the silicon compound film 110, a silicon substrate 20, and a through hole 137 in the silicon substrate 20 according to a comparative example. The through hole 117 communicates with the through hole 137 to form a liquid discharge hole 150. The central axes of the through hole 117 and through hole 137 are almost coincident. The through hole 137 is formed by performing the Bosch process on the silicon substrate 20, in the same way as in the exemplary embodiment. In the comparative example, the amount of side etching on the silicon substrate 20 directly below the silicon compound film 110 is large, and a large protrusion portion 140 is formed in the silicon oxide film. The amount of side etching refers to the amount of etching in the radial direction. The protrusion portion 140 hardly changes even if the Bosch process is continuously performed, which causes an increase in the liquid path resistance of the liquid discharge hole. The present invention will be described in more detail with the exemplary embodiment and the comparative example.

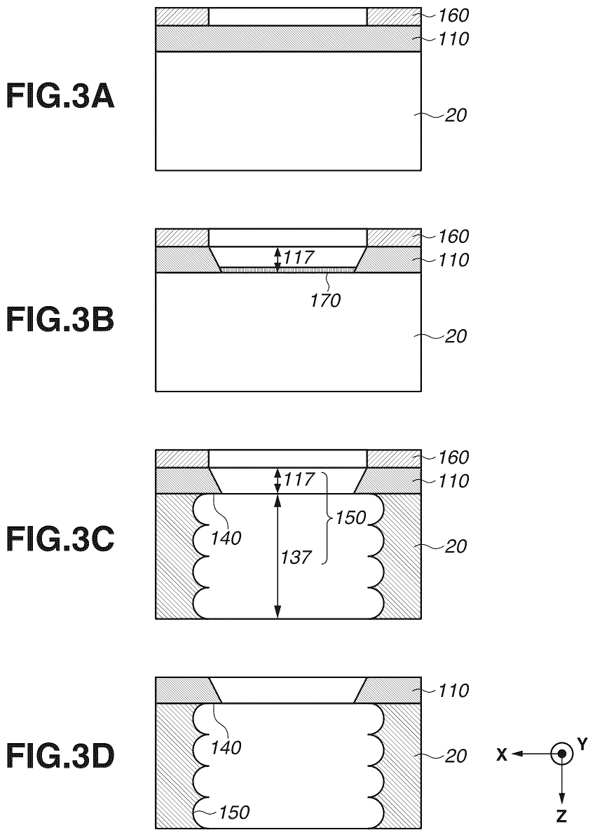

FIGS. 3A to 3D illustrate a process for forming the liquid discharge hole 150 in the comparative example. The discharge hole was set to be a circular shape with a diameter of φ20 μm. As illustrated in FIG. 3A, a photoresist was applied, and a resist mask 160 was provided with a pattern of the through hole 117 to be formed in the oxide film 110 by photolithography.

As illustrated in FIG. 3B, the silicon oxide film 110 was etched via the resist mask 160 to form the through hole 117 in the silicon oxide film 110. In general, a silicon oxide film is etched using mixed gas of C₄F₈ gas (octafluorocyclobutane gas), CF₄ gas, and Ar gas. After the formation of the through hole 117, a by-product 170 enters the through hole 117 and becomes deposited on the bottom of the through hole 117, that is, on the silicon substrate 20. The by-product 170 refers to a mixture of an etching by-product and a deposition film containing carbon and fluorine. The C₄F₈ gas is used to improve the straightness of etching of the silicon oxide film 110. However, in the comparative example, C₄F₈ gas was not used in order to explain the effect of the exemplary embodiment. That is, the etching gas was mixed gas of CF₄ gas and Ar gas that did not contain C₄F₈ gas.

The conditions for etching the silicon oxide film 110 were as follows. In general, in etching the silicon oxide film 110, the pressure of the etching gas was controlled in the range of 0.1 Pa to 5 Pa, the flow rate of the etching gas was controlled in the range of 10 sccm to 1000 sccm, and the power applied to the coil was controlled in the range of 1000 W to 2000 W. In the comparative example, the pressure of the etching gas, which was mixed gas of CF₄ gas and Ar gas, was set to 0.3 Pa, the flow rate of the etching gas was set to 200 sccm, and the power applied to the coil was set to 1500 W. It was confirmed in a test other than the comparative example that the film thickness of the by-product 170 in the comparative example was small and was below the measurement limit.

As illustrated in FIG. 3C, the Bosch process was performed on the silicon substrate 20 via the resist mask 160 and the through hole 117 until the through hole 137 was provided in the silicon substrate 20. SF₆ gas was used as the etching gas, and C₄F₈ gas was used as the coating gas. Thereafter, the resist mask 160 was removed as illustrated in FIG. 3D. The diameter of the liquid discharge hole 150 in the silicon substrate 20 was larger than the diameter of the opening of the through hole 117 in the silicon oxide film 110 at the boundary plane with the silicon substrate 20. In other words, the cross-sectional area of the liquid discharge hole 150 in the silicon substrate 20 was larger than the cross-sectional area of the opening of the silicon oxide film 110 at the boundary plane with the silicon substrate 20. Accordingly, the protrusion portion 140 was formed. The radial length of the protrusion portion 140 was about several μm. However, in particular, when the diameter of the liquid discharge hole 150 in the silicon substrate 20 is about 50 μm or less and a highly viscous liquid is to be discharged from the liquid discharge hole 150, the protrusion portion 140 may cause an increase in flow path resistance of the liquid discharge hole 150. This increase in the flow path resistance affects meniscus vibration of the liquid, making liquid discharge unstable.

The conditions for the Bosch process are as described below. In the Bosch process, generally, SF₆ gas is used as the etching gas, and C₄F₈ gas is used as the protective film coating gas. In the etching step and the protective film formation step, the gas pressure is controlled in the range of 0.1 Pa to 50 Pa, and the gas flow rate is controlled in the range of 50 sccm to 1000 sccm. The time for the etching step is controlled between 5 seconds and 20 seconds, and the time for the protective film formation step is controlled between 1 second and 10 seconds. In order to increase the etching rate for the purpose of shortening the required time, the gas pressure is set to 10 Pa or more, the gas flow rate is set to 500 sccm or more, and the time for the etching step is set to 5 seconds or more. In the comparative example, as in the general Bosch process, SF₆ gas and C₄F₈ gas were used, the gas pressure was controlled to 10 Pa, the gas flow rate was controlled to 700 sccm, the time for the etching step was controlled to 10 seconds, and the time for the coating step was controlled to 5 seconds, thereby to form a flow path with high verticality.

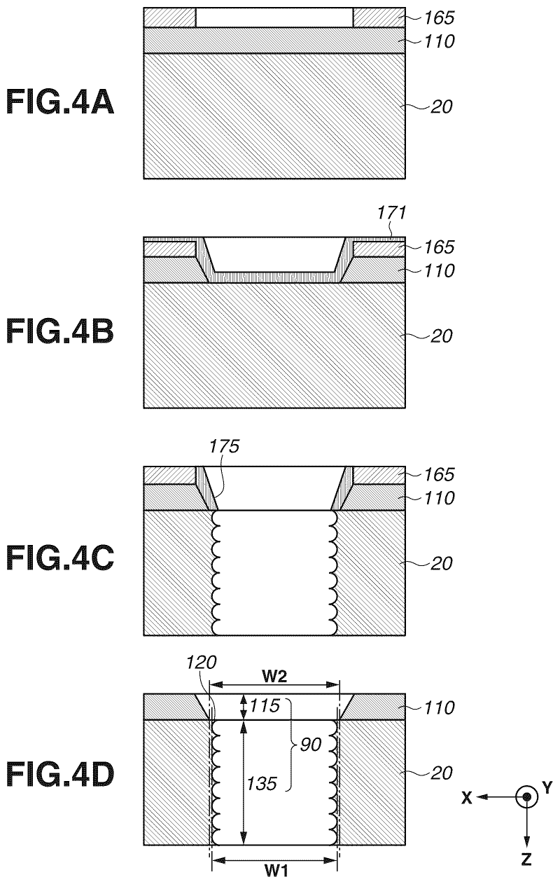

FIGS. 4A to 4D illustrate a process for forming a liquid discharge hole 90 according to the exemplary embodiment. The discharge hole was set to be a circle with a diameter of φ20 μm. As illustrated in FIG. 4A, a resist mask 165 having a pattern of the through hole 115 to be formed in the oxide film 110 was provided in the same manner as in FIG. 3A.

Next, as illustrated in FIG. 4B, the silicon oxide film 110 was etched via the resist mask 165 to form the through hole 115 in the silicon oxide film 110. In order to facilitate the generation of the by-product 171, the flow rate of the C₄F₈ gas contained in the etching gas was set to 100 sccm. Therefore, a larger amount of by-product 171 than the by-product 170 illustrated in FIG. 3B was deposited on the silicon substrate 20, on the sidewalls of the resist mask 165 and the silicon oxide film 110, and on top of the resist mask 165. The conditions for etching the silicon oxide film in the exemplary embodiment were as follows. The pressure of the etching gas, which was mixed gas of C₄F₈ gas, CF₄ gas, and Ar gas, was set to 0.3 Pa, the flow rate of the etching gas was set to 200 sccm, and the power applied to the coil was set to 1500 W. The flow rate of the C₄F₈ gas in the etching gas was set to 100 sccm as described above. Even if the flow rate of the C₄F₈ gas is increased to more than 100 sccm, the effect is small. In general, in order to increase the generation amount of the by-products 171, it is preferable to set the flow rate of the C₄F₈ gas in the entire area of the through hole 115 to 30 sccm or more and 100 sccm or less.

As illustrated in FIG. 4C, the through hole 137 was formed in the silicon substrate 20 by the Bosch process. In the exemplary embodiment, as in the general manufacturing method, SF₆ gas and C₄F₈ gas were used, the gas pressure was set to 3 Pa, the gas flow rate was set to 300 sccm, the step for the etching step was set to 3 seconds, and the time for the protective film formation step was set to 1 second to form a flow path with high verticality. At this time, the by-product 171 attached to the upper surface of the resist mask 165 and the upper surface of the silicon substrate 20 was removed, but the by-product 171 attached to the sidewalls of the resist mask 165 and the silicon oxide film 110 remained (hereinafter, referred to as sidewall residual portion 175). The sidewall residual portion 175 prevents the gas for etching the silicon substrate 20 from contacting the surface of the silicon substrate 20. If the radial thickness of the sidewall residual portion 175 is large, the diameter of the liquid discharge hole 90 directly below the sidewall residual portion 175 becomes small. Accordingly, the radial length of the protrusion portion 140 (see FIGS. 3C and 3D) can be reduced, and can even be reduced to zero.

As illustrated in FIG. 4D, the resist mask 165 and the sidewall residual portion 175 were removed. A protrusion portion 120 of the silicon substrate was formed at the boundary plane between the silicon substrate 20 and the silicon oxide film 110. The length of the protrusion portion 120 was about 0.1 μm or more.

In general, when a hole is formed in a silicon substrate by the Bosch process, a cyclic recess structure is formed in which a plurality of recess portions called scallops is continuously arranged in the depth direction Z. To describe the shape of the scallops, the dimensions will be defined as follows (see FIG. 2).
L1 (scallop cycle): the length in the Z direction of the continuous recess portions formed on the sidewalls of the liquid discharge holes 90 and 150 in the silicon substrate 20
L2 (scallop amplitude): the maximum value of the radial depth of the continuous recess portions formed on the sidewalls of the liquid discharge holes 90 and 150 of the silicon substrate 20
   In both the comparative example and the exemplary embodiment, the Bosch process was controlled so that the scallops were uniform in shape, and L1 and L2 were almost constant. The shape of the sidewall of the liquid discharge hole 150 in the comparative example had a scallop cycle L1 of about 5 μm and a scallop amplitude L2 of about 1 μm as illustrated in FIG. 2B. The shape of the sidewall of the liquid discharge hole 90 in the exemplary embodiment had a scallop cycle L1 of about 0.4 μm and a scallop amplitude L2 of about 0.1 μm as illustrated in FIG. 2A.

Due to the size reduction in the scallops in the exemplary embodiment as described above, a maximum diameter W1 of the liquid discharge hole 90 in the silicon substrate 20 is smaller than a diameter W2 of the liquid discharge hole 90 in the surface of the silicon oxide film 110 that is in contact with the silicon substrate 20, or the maximum value of cross-sectional area of the liquid discharge hole 90 in the silicon substrate 20 is smaller than the minimum value of cross-sectional area of the liquid discharge hole 90 in the silicon oxide film 110.

The advantages of this configuration will be described below.

The liquid discharge head has a large number of liquid discharge holes 90. For favorable liquid discharge, it is desirable to make the overall shape of the liquid discharge holes 90 within a certain tolerance range after accumulating design tolerances. The sum of the tolerances becomes smaller when the scallops are reduced in size. One example of a parameter related to the overall shape is the diameter of the liquid discharge holes 90 in the surface of the silicon oxide film 110 that is in contact with the silicon substrate 20, and the variation in the diameter between the liquid discharge holes 90 becomes smaller when the scallops are reduced in size. Because the flow resistance is decreased and the meniscus vibration is stabilized in each liquid discharge hole 90, the supply of ink to the entire liquid discharge head is stabilized even when the discharge interval is short, so that it can be expected that ink-refilling performance of the liquid discharge holes 90 for continuous discharge will be improved. According to the exemplary embodiment, favorable results were obtained at a test in which ink was discharged onto a recording medium without gaps, and stabilization of the liquid discharge and improvement in the printing quality were achieved as compared to the comparative example.

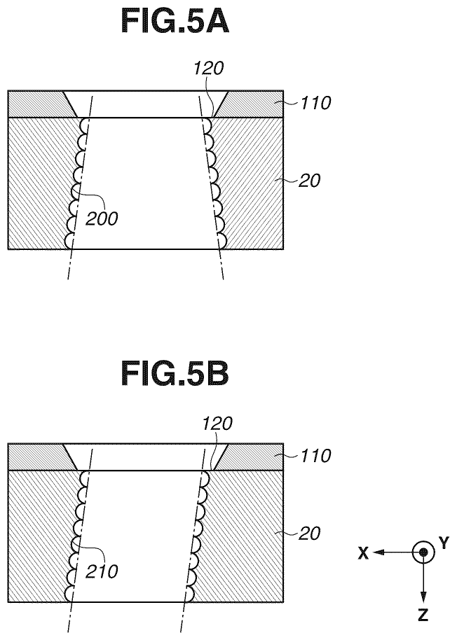

The shape of the liquid discharge holes 90 in the silicon substrate 20 is not limited to the cross-sectional shape extending perpendicularly from the substrate surface. For example, as illustrated in FIG. 5A, the diameter of a liquid discharge hole 200 in the silicon substrate 20 may be formed so as to become larger as farther away from the silicon oxide film 110 in the Z direction. As illustrated in FIG. 5B, a liquid discharge hole 210 may be formed in the silicon substrate 20 so that the central axis of the liquid discharge hole 210 is not perpendicular to the boundary plane between the silicon substrate 20 and the silicon oxide film 110. Even in these two cases, it was confirmed that the protrusion portion 140 disappeared and the protrusion portion 120 was formed due to the sidewall residual portion 175, which is a feature of the exemplary embodiment, and that the effect of printing in the exemplary embodiment remained unchanged.

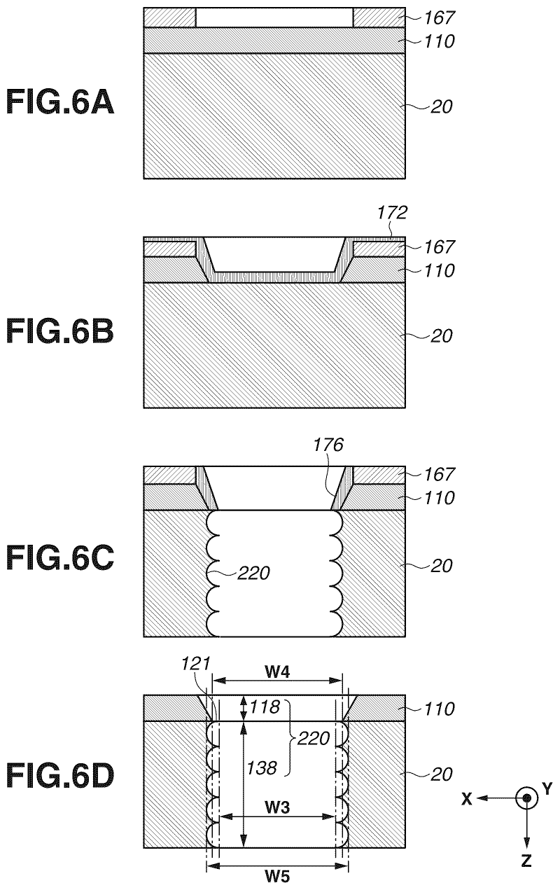

FIGS. 6A to 6D illustrate a process for forming a liquid discharge hole 220 according to a modification example. As illustrated in FIG. 6A, a resist mask 167 having a pattern of a through hole to be formed in an oxide film 110 was provided, as in the exemplary embodiment of FIG. 4A.

In the present modification example, as illustrated in FIG. 6B, a silicon oxide film 110 was etched via the resist mask 167 to form a through hole 118 in the silicon oxide film 110.

As the etching conditions for the silicon oxide film 110 used in the present modification example, the pressure of etching gas that was mixed gas of C₄F₈ gas, CF₄ gas, and Ar gas was set to 0.3 Pa, the flow rate of the etching gas was set to 200 sccm (including a flow rate of 30 sccm of the C₄F₈ gas), and the power applied to the coil was set to 1500 W. A by-product 172 was deposited on a silicon substrate 20, on the sidewalls of the resist mask 167 and silicon oxide film 110, and on top of the resist mask 167. However, the amount of deposition was less than that of the by-products 171 illustrated in FIG. 4B. This is because the flow rate of C₄F₈ gas was changed from 100 sccm to 30 sccm.

As illustrated in FIG. 6C, a through hole 138 was formed in the silicon substrate 20 by the Bosch process. In the modification example, a highly vertical flow path was formed by using SF₆ gas and C₄F₈ gas, setting the gas pressure to 10 Pa, setting the gas flow rate to 500 sccm, setting the time for the etching step to 6 seconds, and setting the time for the protective film formation step to 3 seconds. At this time, the by-product 172 attached to the upper surface of the resist mask 167 and the upper surface of the silicon substrate 20 was removed, but the by-product 172 attached to the sidewalls of the resist mask 167 and silicon oxide film 110 remained to form a sidewall residual portion 176. The scallops of the liquid discharge hole 220 on the side surfaces of the silicon substrate 20 had a scallop cycle L1 of 0.8 μm and a scallop amplitude L2 of 0.2 μm, which were larger than the scallops of the liquid discharge hole 90 on the side surfaces of the silicon substrate 20 in the exemplary embodiment, but were smaller than the scallops of the liquid discharge hole 150 on the side surfaces of the silicon substrate 20 in the comparative example.

As illustrated in FIG. 6D, the resist mask 167 and the sidewall residual portion 176 were removed. A protrusion portion 121 of the silicon substrate 20 was formed at the boundary plane between the silicon substrate 20 and the silicon oxide film 110. Because the radial length of the sidewall residual portion 176 was smaller than the radial length of the sidewall residual portion 175, the radial length of the protrusion portion 121 was about 0.1 μm or less, which was smaller than the radial length of the protrusion portion 120. A maximum value W5 of the diameter of the liquid discharge hole 220 in the silicon substrate 20 was larger than a minimum value W4 of the diameter of the liquid discharge hole 220 in the silicon oxide film 110, and a minimum value W3 of the diameter of the liquid discharge hole 220 in the silicon substrate 20 was smaller than the minimum value W4 of the diameter of the liquid discharge hole 220 in the silicon oxide film 110. In other words, the maximum value of the cross-sectional area of the liquid discharge hole 220 in the silicon substrate 20 was larger than the minimum value of the cross-sectional area of the liquid discharge hole 220 in the silicon oxide film 110, and the minimum value of the cross-sectional area of the liquid discharge hole 220 in the silicon substrate 20 was smaller than the minimum value of the cross-sectional area of the liquid discharge hole 220 in the silicon oxide film 110. That is, the diameter or cross-sectional area of the through hole that is the liquid discharge hole 220 in the silicon substrate 20 had a dimensional tolerance in both the directions in which the diameter was larger and smaller than that of the opening of the silicon oxide film 110 at the boundary plane with the silicon substrate 20.

As a result of performing an ink discharge test using the liquid discharge hole 220 illustrated in FIG. 6D, it was confirmed that the meniscus vibration was stabilized, the ink discharge was stabilized, and the print quality was improved, as compared to the case where the liquid discharge hole 150 according to the comparative example was used. However, since the scallops in the exemplary embodiment were smaller than those in the present modification example, the scallops in the exemplary embodiment are more effective. Because the scallops in the modification example are larger than those in the exemplary embodiment, the number of repetitions of a cycle for forming individual scallops to form the through hole 138 in the silicon substrate 20 can be reduced. Accordingly, it is advantageous in that the process for forming the through hole 138 is simple and takes less time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-140399, filed Aug. 30, 2023, which is hereby incorporated by reference herein in its entirety.

What is claimed is:

1. A laminated substrate comprising:
a silicon substrate; and
a silicon compound film stacked on the silicon substrate,
wherein the silicon compound film has a through hole,
wherein the silicon substrate has a hole communicating with the through hole, and
wherein a diameter or a cross-sectional area of the hole is smaller at least at a portion in a depth direction of the hole than a diameter or a cross-sectional area of the through hole on a surface in contact with the silicon substrate.

2. The laminated substrate according to claim 1, wherein the hole is a through hole penetrating the silicon substrate.

3. The laminated substrate according to claim 1, wherein the silicon compound film contains one or more of SiO, SiO₂, Si₃N₄, SiN, SiC, SiON, SiOC, SiCN, and SiOCN.

4. The laminated substrate according to claim 1, wherein the silicon compound film is a silicon oxide film.

5. The laminated substrate according to claim 1, wherein the diameter of the hole is smaller over an entire area in the depth direction of the hole than the diameter of the through hole on the surface in contact with the silicon substrate.

6. The laminated substrate according to claim 1, wherein the diameter of the hole is smaller at a portion in the depth direction of the hole than the diameter of the through hole on the surface in contact with the silicon substrate.

7. A laminated substrate comprising:
a silicon substrate; and
a silicon compound film stacked on the silicon substrate,
wherein the silicon compound film has a through hole,
wherein the silicon substrate has a hole communicating with the through hole, and
wherein a diameter of a cross-sectional area of the hole is smaller at least at a portion in a depth direction of the hole than a diameter of a cross-sectional area of the through hole on a surface in contact with the silicon substrate.

8. A liquid discharge head comprising:
a silicon substrate; and
a silicon compound film stacked on the silicon substrate,
wherein the silicon compound film has a through hole,
wherein the silicon substrate has a hole communicating with the through hole, and
wherein a diameter of the hole is smaller at least at a portion in a depth direction of the hole than a diameter of the through hole on a surface in contact with the silicon substrate.

9. A method for manufacturing a laminated substrate including a silicon substrate and a silicon compound film stacked on the silicon substrate, the method comprising:
forming a through hole in the silicon compound film stacked on the silicon substrate; and
forming a hole in the silicon substrate, the hole communicating with the through hole in the silicon compound film,
wherein a by-product is generated in the forming the through hole, a portion of the by-product being attached to a sidewall of the through hole in the silicon compound film,
wherein the forming the hole is performed in a state where the by-product is attached to the sidewall of the through hole, and
wherein the method further comprises removing the by-products after forming the through hole and the hole.

10. The method for manufacturing a laminated substrate according to claim 9, wherein the silicon compound film contains one or more of SiO, SiO₂, Si₃N₄, SiN, SiC, SiON, SiOC, SiCN, and SiOCN.

11. The method for manufacturing a laminated substrate according to claim 9, wherein the silicon compound film is a silicon oxide film.

12. The method for manufacturing a laminated substrate according to claim 9,
wherein the hole in the silicon substrate is formed by dry etching in which isotropic etching, formation of a sidewall protective film, and anisotropic etching are repeated, and
wherein a diameter of the hole is smaller at least at a portion in a depth direction of the hole than a diameter of the through hole on a surface in contact with the silicon substrate.

13. The method for manufacturing a laminated substrate according to claim 9,
wherein the hole in the silicon substrate is formed by dry etching in which isotropic etching, formation of a sidewall protective film, and anisotropic etching are repeated, and
wherein a cross-sectional area of the hole is smaller at least at a portion in a depth direction of the hole than a cross-sectional area of the through hole on a surface in contact with the silicon substrate.

14. The method for manufacturing a laminated substrate according to claim 9, wherein the through hole in the silicon compound film is formed by etching using gas including octafluorocyclobutane gas.

15. The method for manufacturing a laminated substrate according to claim 14, wherein a flow rate of the octafluorocyclobutane gas is 30 sccm or more and 100 sccm or less.
